(19) United States
(12) Patent Application Publication
(10) Pub. No.: US 2007/0208698 A1
(43) Pub. Date: Sep. 6, 2007

(54) Avoiding duplicate service requests

(76) Inventors: Dougal Brindley, Alameda, CA (US); Anthony Deighton, San Francisco, CA (US); Ken Wells, Foster City, CA (US); Mitchell Kreaden, San Mateo, CA (US); Mark Sunday, Redwood City, CA (US)

Correspondence Address: CSA LLP, 4807 SPICEWOOD SPRINGS RD., BLDG. 4, SUITE 201, AUSTIN, TX, 78759, US

(21) Appl. No.: 10/165,567

(22) Filed: Jun. 7, 2002

(51) Int. Cl. G06F 17/30

(52) U.S. Cl. 707/3

(57) ABSTRACT

A facility for screening service requests for requesting assistance is described. The facility receives a service request requesting assistance with solving a problem associated with an asset accessible to a user. Upon request by the user, the facility searches a collection of pending service requests for a potential duplicate service request that is likely to identify the same problem as the received service request. When the system identifies a potential duplicate service request, the system notifies the user of the potential duplicate service request, giving the user an opportunity to address the duplicate service request at the same time that the user addresses the received service request.

### TECHNICAL FIELD

The following disclosure relates generally to request submission.

### BACKGROUND

Organizations are increasingly implementing and relying on internal systems that function over a wide-base infrastructure, such as intranets. When problems occur that are related to the use of such systems, members of the organization and other users, such as employees and customers, may call or send a message to a helpdesk or support center run by a support staff (consisting of helpdesk agents) in order to seek assistance. Once a user reports a problem or requests assistance to solve a problem, a helpdesk agent may generate a trouble ticket to log the report or request. The support staff then investigates the problem that is affecting the user, which is often related to an infrastructure outage or some sort of planned or unplanned diminished service. For example, an employee attempting to use a printer connected to a network may experience difficulty when attempting to print a document. The employee may not completely understand the problem, but has enough knowledge that he or she may provide a general description of the problem (e.g., “the printer on the third floor is not printing”) to a helpdesk agent, who then generates a report. Eventually, one or more helpdesk agents are assigned to investigate and ultimately resolve the printer problem.

While there are several different categories of helpdesk service requests (e.g., “how to,” “request for change,” “break/fix,” etc.), industry reports reflect that infrastructure outages typically make up a significant percentage of total helpdesk service requests (approximately eighteen percent of all helpdesk service requests). Often, where a problem is related to an infrastructure outage or diminished service of a system or subsystem, the support staff may receive several service requests relating to the same problem, but they have no way to convey such knowledge to others within the organization. For example, if the problem with the networked printer described in the above-cited example is related to a planned maintenance outage, several employees may be experiencing problems with one or more printers on the network. Although the support staff already knows of the problem, its members may be required to respond to multiple service requests for assistance relating to the same problem. Receiving large numbers of such redundant service requests often prevents the support staff from addressing other issues and results in inefficient use of the organization's resources. Recent industry reports estimate that each service request contact costs an organization an average of sixteen dollars.

While a user submitting a service request requesting assistance with a particular problem may not know whether another user has already submitted a similar service request for the same problem, once service requests reach a helpdesk, helpdesk agents may be able to recognize duplicate service requests by reviewing their descriptions. Where there are many service requests to process, however, the task of identifying duplicate service requests from a large collection of service requests may be time consuming, especially when the duplicate service requests may all have varying descriptions. Moreover, if there is more than one agent working at the helpdesk to process service requests, identifying duplicate service requests may become even more difficult because of the coordination involved in such a task.

Accordingly, it would be desirable to have a tool that notifies a helpdesk agent about the existence of potential duplicate service requests.

### BRIEF DESCRIPTION OF THE DRAWINGS

FIG. 1 shows a multi-layered system architecture in which the teachings of the present invention are implemented.

FIG. 2 shows a block diagram of one embodiment of a system configuration in which the teachings of the present invention are implemented.

FIG. 3 shows a block diagram illustrating another logical representation of a multi-layered architecture in which applications can be built in accordance with the teachings of the present invention.

FIG. 4 illustrates a block diagram of one embodiment of an application framework in which the teachings of the present invention may be implemented.

FIG. 5 is a sample user interface showing a web page through which a user may input information in order to create a service request.

FIG. 6 is a sample user interface showing a web page displaying pending service requests.

FIG. 7 is a first sample user interface showing a window or web page displaying potential duplicate service requests.

FIG. 8 is a second sample user interface showing a window or web page displaying potential duplicate service requests.

FIG. 9 is a flow diagram showing steps typically performed by the facility to process a find duplicates request in some embodiments.

FIG. 10 is a flow diagram showing steps typically performed by the facility to processes a find duplicates request in an alternate embodiment.

### DETAILED DESCRIPTION

### I. Introduction

A facility for identifying potential duplicate service requests is provided. In some embodiments, the facility notifies a helpdesk agent processing a service request if a selected pending service request is related to other pending service requests that have been submitted by other requesters, thereby enabling the helpdesk agent to address any duplicate service requests simultaneously. For example, a sudden floor-wide voicemail outage may cause eight different employees to submit online service requests indicating that their voicemail is not working properly, all within a one-hour period. The facility then identifies potential duplicate service requests within a store of submitted service requests. The facility displays potential duplicate service requests in a list on the helpdesk agent's computer as a distinct group of related service requests. The helpdesk agent may then select individual service requests from the displayed list of potential duplicate service requests in order to consolidate the service requests. Consolidated service requests may then be addressed efficiently as a group. For example, the consolidated service requests may be logged using a single trouble ticket. Additionally, the facility may notify, as a group, the requesters of consolidated service requests that their service requests are in the process of being addressed.

By providing a standardized facility for submitting service request information, one or more information fields of a service request such as time, title, type, area, subarea and description may be compared with similar fields in other pending service requests. The comparisons may involve searching for exact matches (e.g., using a standardized “TYPE” field), searching for keywords (e.g., using a “description” field) and/or searching within a specified range (e.g., searching for service requests submitted within two-hour time period).

The advantages realized by the use of some embodiments of the facility include more efficient processing of redundant service requests, especially in the case where redundant service requests are interspersed within a large collection of pending service requests.

### II. Facility Overview and Overall Architecture

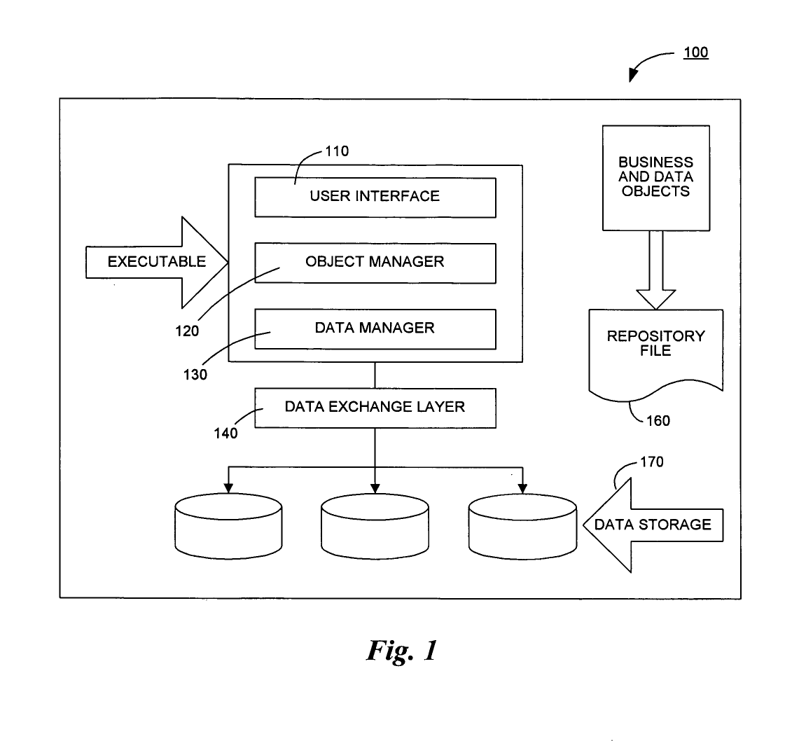

In some embodiments, a system in which the teachings of the present invention are implemented can be logically structured as a multi-layered architecture as shown in FIG. 1. In some embodiments, the logical multi-layered architecture as shown in FIG. 1 provides a platform for common services to support the various applications. These services may include a user interface layer 110, an object manager layer 120, a data manager layer 130 and a data exchange layer 140.

In some embodiments, the user Interface layer 110 may provide the applets, views, charts and reports, etc. associated with one or more applications. In some embodiments, various types of clients can be supported via the user interface layer 110. These various types of clients may include traditional connected clients, remote clients, thin clients over an intranet, Java thin clients or non-Windows-based operating systems, and HTML clients over the Internet, etc.

In some embodiments, the object manager layer 120 is designed to manage one or more sets of business rules or business concepts associated with one or more applications and to provide the interface between the user interface layer 110 and the data manager layer 130. In some embodiments, the business rules or concepts can be represented as business objects. In some embodiments, the business objects may be designed as configurable software representations of the various business rules or concepts such as accounts, contacts, opportunities, service requests, solutions, etc.

In some embodiments, the data manager layer 130 is designed to maintain logical views of the underlying data and to allow the object manager to function independently of underlying data structures or tables in which data are stored. In some embodiments, the data manager 130 may also provide certain database query functions such as generation of structure query language (SQL) in real-time to access the data. In some embodiments, the data manager 130 is designed to operate on object definitions in a repository file 160 that define the database schema. In some embodiments, the data storage services 170 provide the data storage for the data model associated with one or more applications.

In some embodiments, the data exchange layer is designed to handle the interactions with one or more specific target databases and provide the interface between the data manager layer 130 and the underlying data sources.

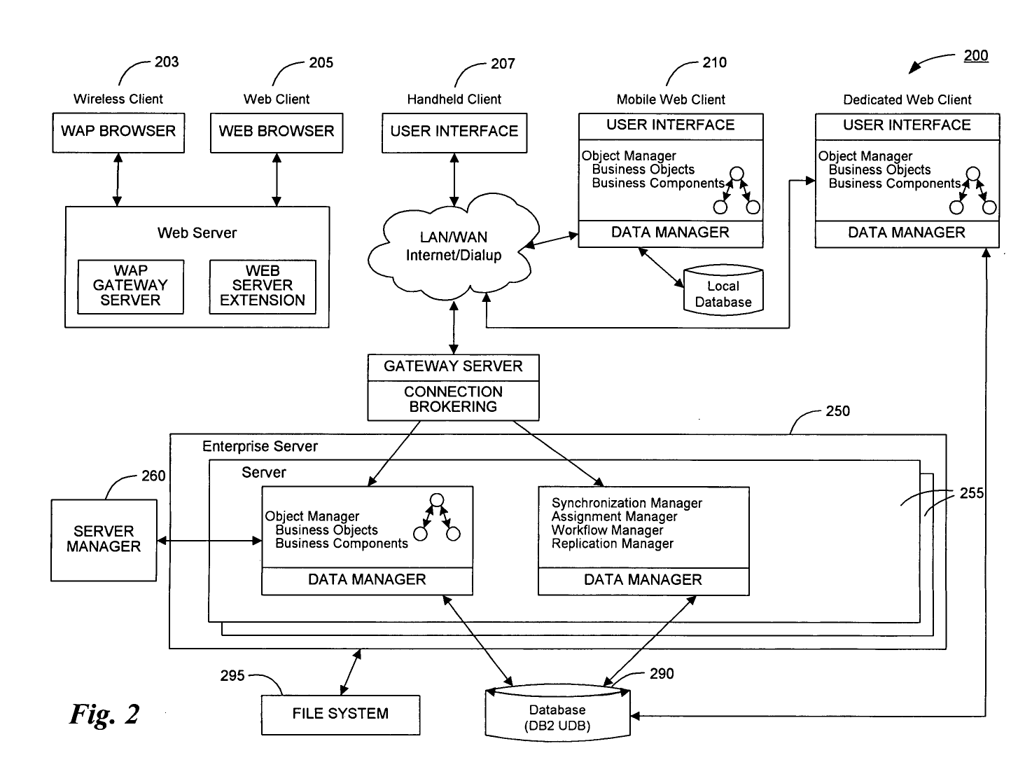

FIG. 2 shows a block diagram of some embodiments of a system configuration in which the teachings of the present invention are implemented.

In some embodiments, the multi-layered architecture allows one or more software layers to reside on different machines. For example, in some embodiments, the user interface, the object manager and the data manager can all reside on dedicated web clients 200. For other types of clients such as the wireless clients 203, in some embodiments, the object manager and data manager can reside on a system server. It should be appreciated and understood by one skilled in the art that the system configuration shown in FIG. 2 is for illustrative and explanative purposes and may vary depending on the particular implementations and applications of the teachings of the present invention.

In some embodiments, the system environment illustrated in FIG. 2 may include more than one database 290. One or more subsets of the database 290 can be created or replicated by a replication manager. In addition, mobile web clients 210 can have additional remote databases (also called local databases). In some embodiments, unless the remote or local databases associated with the mobile web clients 210 are defined as read-only databases, these mobile web clients can create and update data locally that will ultimately be propagated up to the primary database when each mobile web client synchronizes with the system server.

In some embodiments, the database 290 is designed to store various types of data, including predefined data schema (e.g., table objects, index objects, etc.), repository objects (e.g., business objects and components, view definitions and visibility rules, etc.), and user's or customer's data. In some embodiments, dedicated web clients 200 and server components, including those that operate in conjunction with the other types of clients, can connect directly to the database 290 and make changes in real-time. In some embodiments, mobile web clients 210 can download a subset of the server's data to use locally, and periodically synchronize with the server database through the system server to update both the local and the server database.

In some embodiments, various tables included in the database 290 may be logically organized into the following types: data tables, interface tables, repository tables, etc.

In some embodiments, data tables may be used to store user business data, administrative data, seed data, transaction data, etc. In some embodiments, these data tables may be populated and updated through the various applications and processes. In some embodiments, data tables may include the base tables and the intersection tables. In some embodiments, base tables may contain columns that are defined and used by the various applications. In some embodiments, the base tables are designed to provide the columns for a business component specified in the table property of that business component. In some embodiments, intersection tables are tables that are used to implement a many-to-many relationship between two business components. They may also hold intersection data columns, which store information pertaining to each association. In some embodiments, intersection tables provide the data structures for association applets.

In some embodiments, interface tables are used to denormalize a group of base tables into a single table with which external programs can interface. In some embodiments, they may be used as a staging area for exporting and importing of data.

In some embodiments, repository tables contain the object definitions that specify one or more applications regarding:
The client application configuration
The mapping used for importing and exporting data
Rules for transferring data to mobile clients

In some embodiments, the file system 295 is a network-accessible directory that can be located on an application server. In some embodiments, the file system 295 stores the physical files created by various applications, such as files created by third-party text editors, and other data that is not stored in the database 290. In some embodiments, physical files stored in the file system 295 can be compressed and stored under various naming conventions. In some embodiments, dedicated web clients 200 can read and write files directly to and from the file system 295. In some embodiments, mobile web clients 210 can have a local file system, which they periodically synchronize with the server-based file system 295. In some embodiments, other types of clients such as the wireless clients 203 and the web clients 205 can access the file system 295 via the system server.

In some embodiments, the enterprise server 250 is a logical grouping of the system servers 255 that share a common table owner or a database, point to a common gateway Server, and can be administered as a group using a server manager 260. In some embodiments, the connection to the gateway server can be established via TCP/IP. In some embodiments, the enterprise server 250 can be scaled effectively by deploying multiple system servers 255 in the enterprise server 250, thus providing a high degree of scalability in the middle tier of applications.

In some embodiments, the server 255 runs one or multiple server programs. It handles the incoming processing requests and monitors the state of all processes on the server. In some embodiments, server programs are designed and configured to perform one or more specific functions or jobs including importing and exporting data, configuring the database, executing workflow and process automation, processing to support mobile web clients 210 for data synchronization and replication, enforcing business rules, etc. In some embodiments, the server 255 can be an NT Service (under Windows NT operating system) or a daemon (e.g., a background shell process) under UNIX operating system. In some embodiments, the server 255 supports both multi-process and multi-threaded components and can operate components in batch, service and interactive modes.

In some embodiments, the server manager 260 is configured as a utility that allows common control, administration and monitoring across disparate programs for the servers 255 and the enterprise server 250. In some embodiments, the server manager 260 can be used to perform the following tasks: start, stop, pause and resume servers 255, components and tasks; monitor status and collect statistics for multiple tasks, components and servers within an enterprise server; and configure the enterprise server, individual servers, individual components and tasks, etc.

In some embodiments, the gateway server can be configured as a logical entity that serves as a single entry point for accessing servers. In some embodiments, it can be used to provide enhanced scalability, load balancing and high availability across the enterprise server. In some embodiments, the gateway server may include a name server and a connection brokering component. In some embodiments, the name server is configured to keep track of the parameters associated with the servers. For example, the availability and connectivity information associated with the servers can be stored in the name server. The various components in the system can query the name server for various information regarding the servers' availability and connectivity. In a Windows NT environment, the name server can be run as an NT service. In a UNIX environment, the name server can run as a daemon process. In some embodiments, the connection brokering component is used to perform load balancing functions such as directing client connection requests to an appropriate server (e.g., the least-busy server).

In some embodiments, as illustrated in FIG. 2, the various types of clients that can be supported by the system may include the following clients: dedicated web clients 200, mobile web clients 210, web clients 205, wireless clients 203 and handheld clients 207.

In some embodiments, dedicated web clients 200 (also called connected clients) are connected directly to a database server for data access via a LAN or WAN connection. In some embodiments, these connected or dedicated web clients do not store data locally. These dedicated web clients 200 can also access the file system directly. In some embodiments, the user interface, the object manager and the data manager layers of the multi-layered architecture reside on the dedicated web client 200.

In some embodiments, the mobile web clients 210 are designed and configured for local data access and thus can have their own local database and/or local file system. In some embodiments, mobile web clients 210 can interact with other components within the system via the gateway server. Through synchronization, the modifications from the local database and the server database can be exchanged. Mobile web clients 210 are described in more detail below.

In some embodiments, a web client 205 runs in a standard browser format from the client's machine. In some embodiments, the web client 205 can connect to a system server 255 through a web server. In some embodiments, the system server 255 is designed and configured to execute business logic and access data from the database 290 and file system 295. In some embodiments, the web client 205 described herein is designed and configured in accordance with the teachings of the present invention to operate in an interactive mode. In some embodiments, the interactive web client framework as described herein utilizes dynamically created objects implemented in JavaScript on the browser side that correspond to objects on the server side. In some embodiments, these dynamically created objects on the browser side may include the current view and its corresponding applets, the current business object and the corresponding business components, etc. The web client 205 is described in more detail below.

In some embodiments, wireless clients are essentially thin clients enabled on wireless devices. The wireless clients can use a wireless application protocol (WAP)-based user interface to communicate and exchange information/data with the system server.

The system configuration illustrated in FIG. 2 is described in more detail below with references to various structures, databases, tables, file systems, etc., as illustrating examples.

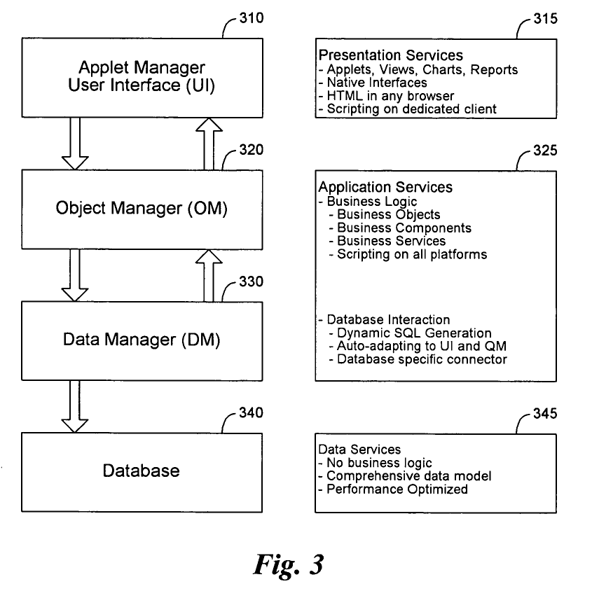

FIG. 3 shows a block diagram illustrating another logical representation of a multi-layered architecture in which applications can be built in accordance with the teachings of the present invention. Again, the multi-layered architecture as illustrated in FIG. 3 provides the configured platform for various common services designed to support the various applications. In some embodiments, these various services may include presentation services logic layer 315, which corresponds to an applet manager and user interface layer 310, application services logical layer 325, which corresponds to an object manager (OM) layer 320, and a data manager (DM) layer 330 and data services logical layer 345, which correspond to a database layer 340.

In some embodiments, the presentation services 315 may be designed and configured to support various types of clients and may provide them with user interface applets, views, charts and reports, etc. As described above, a large variety of clients may be supported (e.g., wireless clients, handheld clients, web clients, mobile web clients, dedicated (connected) clients, etc.).

In some embodiments, the application services 325 may include business logic services and database interaction services. In some embodiments, business logic services provide the class and behaviors of business objects and business components. In some embodiments, database interaction services may be designed and configured to take the user interface (UI) request for data from a business component and generate the database commands (e.g., SQL queries, etc.) necessary to satisfy the request. For example, the data interaction services may be used to translate a call for data into DBMS-specific SQL statements.

In some embodiments, data services 345 may be designed and configured to provide the data storage for the underlying data model that serves as the basis of the various applications. For example, the data model may be designed and configured to support various software products and applications including call center, sales, services and marketing, etc., as well as various industry vertical products and applications such as eFinance, eInsurance, eCommunications and eHealthcare.

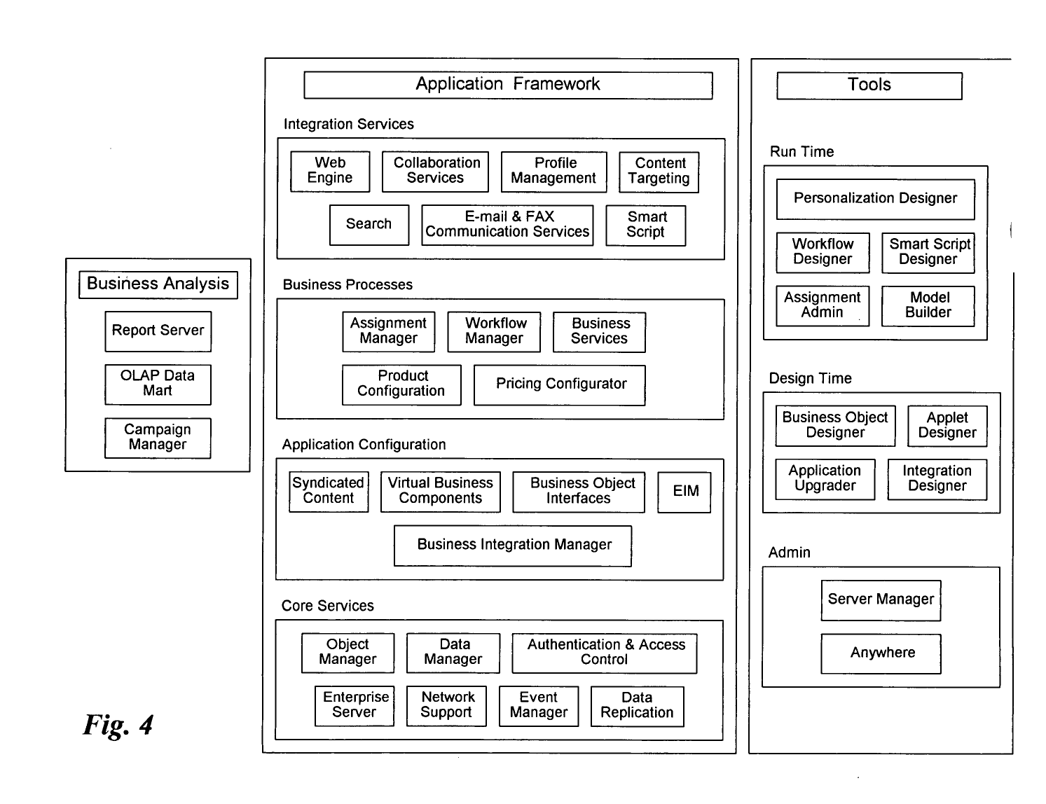

FIG. 4 illustrates a block diagram of some embodiments of an application framework in which the teachings of the present invention may be implemented. As illustrated in FIG. 4, the application framework may include various logical groupings of various types of services and various types of tools that can be used to design and configure particular applications based on business needs and environments.

In some embodiments, the core services are designed and configured to provide the framework in which the applications execute. In some embodiments, the core services may include the following:
The enterprise server, which is the middle-tier application server
The networks that link all of these pieces together
Facilities like event manager and data replication, which allow sharing data between multiple installations of various applications, as well as between the various applications and other external applications
The authentication, access control and security facilities.

In some embodiments, application integration services may be designed and configured to allow the various applications built in accordance with this framework to communicate with the external world. In some embodiments, the various types of services in this logical grouping may be designed and configured to provide for real-time, near-real-time and batch integration with external applications. For example, these integration services may be used to enable communications between external applications and internal applications using available methods, technologies and software products. In some embodiments, application integration services allow the systems or applications to share and replicate data with other external enterprise applications. Accordingly, these services allow a particular application or system to be both a client requesting information and a server having information requested from it.

In some embodiments, business processes services are designed and configured to allow the client to automate business processes through the application. In some embodiments, these various business process services may include the following:
Assignment of tasks through Assignment Manager
Enforcement of business practices through Workflow Manager
Reuse of custom business logic through Business Services
Ensuring proper product configuration and pricing through the Product Configurator and Pricing Configurator

In some embodiments, creation of these business processes can be done through Run-Time tools such as Personalization Designer, Workflow Designer, SmartScript Designer, Assignment Administration Views and Model Builder.

In some embodiments, integration services may be designed and configured to provide the client with user interface and thin client support. In some embodiments, these may include capabilities for building and maintaining web-based applications, providing web support facilities such as user Profile Management, Collaboration Services and Email and Fax services, advanced Smart Scripting, etc.

In some embodiments, design time tools may be designed and configured to provide the services to customize, design, provide integration points and maintain the application. These various tools provide one common place to define the application.

In some embodiments, administrative services are designed and configured to provide one place to monitor and administer the application environment. In some embodiments, these services allow the user to administer the application either through a graphic user interface (GUI) or from a command line, etc.

### III. User Interface and Finding Duplicate Service Requests

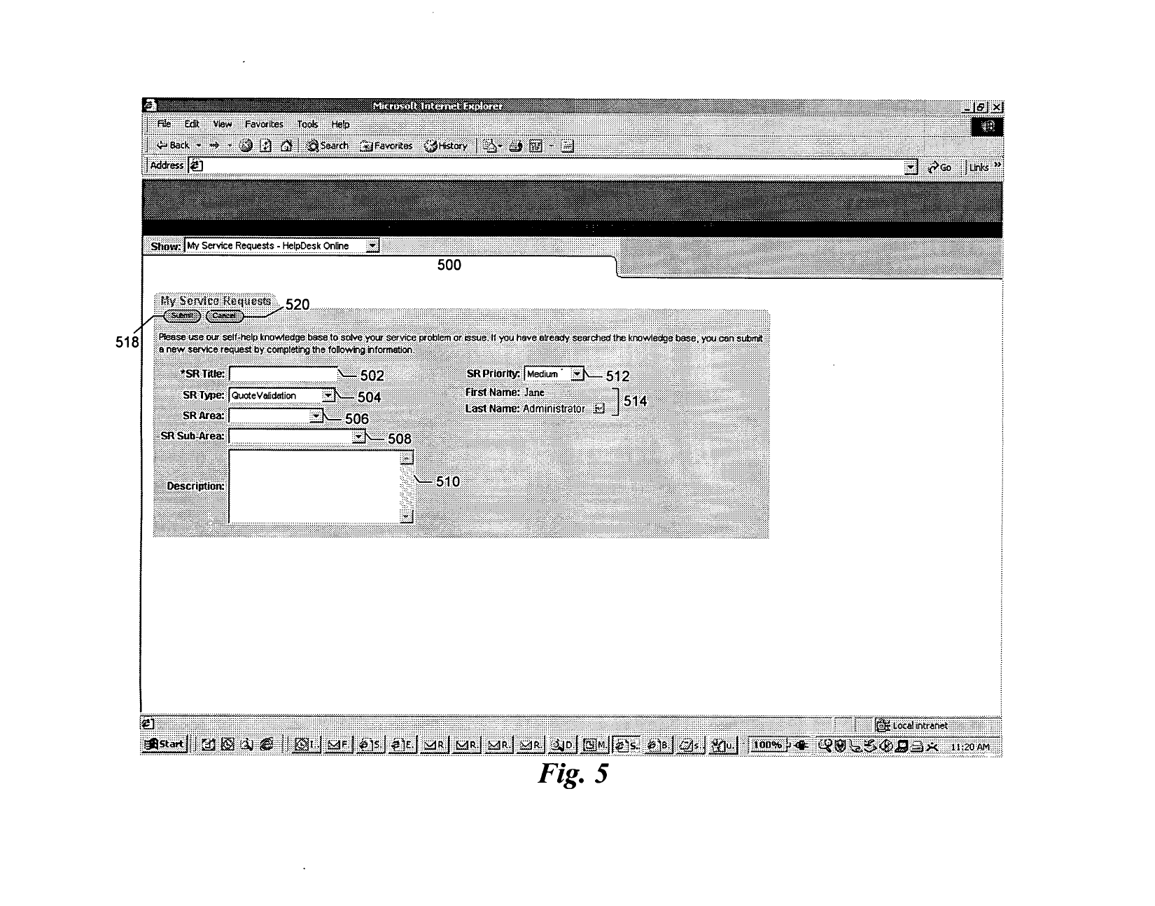

FIGS. 5-8 illustrate sample user interfaces provided by some embodiments of the electronic duplicate service requests screening system. The terms “screen,” “window,” “web page” and “page” are generally used interchangeably herein. The web pages described herein may be implemented using, for example, XML (extensible markup language) or HTML (hypertext markup language) scripts that provide information to a user. The web pages are stored and/or transmitted as display descriptions, graphical user interfaces or other methods of depicting information on a computer screen where the layout and information or content to be displayed on the page is stored in a database or other storage facility. While aspects of the invention are described using a network environment, some or all features may be implemented within a single-computer environment.

FIG. 5 is a sample user interface showing a “MY SERVICE REQUESTS—HELPDESK ONLINE” page 500 through which a user creating a service request (herein a “requester”) may enter information in order to create a service request. An “SR TITLE” field 502 holds a title for the service request that may be used to quickly identify the nature of the service request. An “SR TYPE” 504 drop-down menu provides a list of service request categories from which the requester may select the category that best corresponds to the service request type. In this example, the requester has requested a problem relating to “quote validation.” Other examples of service request types include “Competency,” “Support,” “Facilities,” “Finance,” “Human Relations,” “IT/eBiz,” “Payroll,” “Training” and “My Company.” One skilled in the art would recognize, however, that various other request types are possible.

From the “MY SERVICE REQUESTS—HELPDESK ONLINE” page 500, the requester may select an item from an “SR AREA” drop-down menu 506. In some embodiments, the particular SR area selected by the requestor corresponds to a particular system that may be the basis of the requestor's service request. Examples of SR areas include “Facilities,” “Finance,” “Human Resources,” “IT,” “Mfgops” and “Payroll.” For purposes of illustration, examples of subareas within an “IT” area may include “Hardware Break/Fix,” “Desktop Hardware,” “Dial-up,” “File Sharing,” “Laptop Hardware,” “Local Connectivity,” “Net Conference,” “Net meeting,” “Password,” “Printing,” “TelephoneNoicemail” and “Windows 2000.” Examples of subareas within a “Facilities” area may include “Air Conditioning,” “Doors,” “Electrical,” “Elevators,” “Furniture,” “General Exterior,” “Plumbing,” “Security,” “Appliances,” “Lighting,” “Facilities/conference,” “Moves,” “Locks,” “Recycling” and “Refreshments.”

The following example further illustrates the use of the “SR AREA” 506 and “SR SUBAREA” 508 fields as provided in some embodiments. An employee having problems with the temperature of his office being too cold may create a service request choosing “Facilities” for both the “SR TYPE” 504 and the “SR AREA” 506 fields and “Air Conditioning” for the “SR SUBAREA” 508 field. Besides being used as a means for identifying duplicate service requests, the information provided in the “SR AREA” 506 and “SR SUBAREA” 508 fields may be useful for purposes such as determining the appropriate recipient of the service request or describing a problem so that appropriate measures may be taken to address the problem. The information provided by the user in a “DESCRIPTION” text area 510, in some embodiments, may also serve a similar function.

Once the requester has entered information about the type of the request, the requester may select a priority for the service request (e.g., “Very High,” “High,” “Medium,” “Low,” etc.) using the “PRIORITY” drop-down menu 512. In some embodiments, the first and last name of the requester 514 is automatically displayed in corresponding text fields of the service request. In an alternate embodiment, the requester may be prompted to input his or her name, location and/or other identifying information, such as an email address or phone number. In some embodiments, when the requester has inputted the appropriate service request information, the requester may submit the service request by selecting a “SUBMIT” button 518, or cancel the service request by selecting a “CANCEL” button 520.

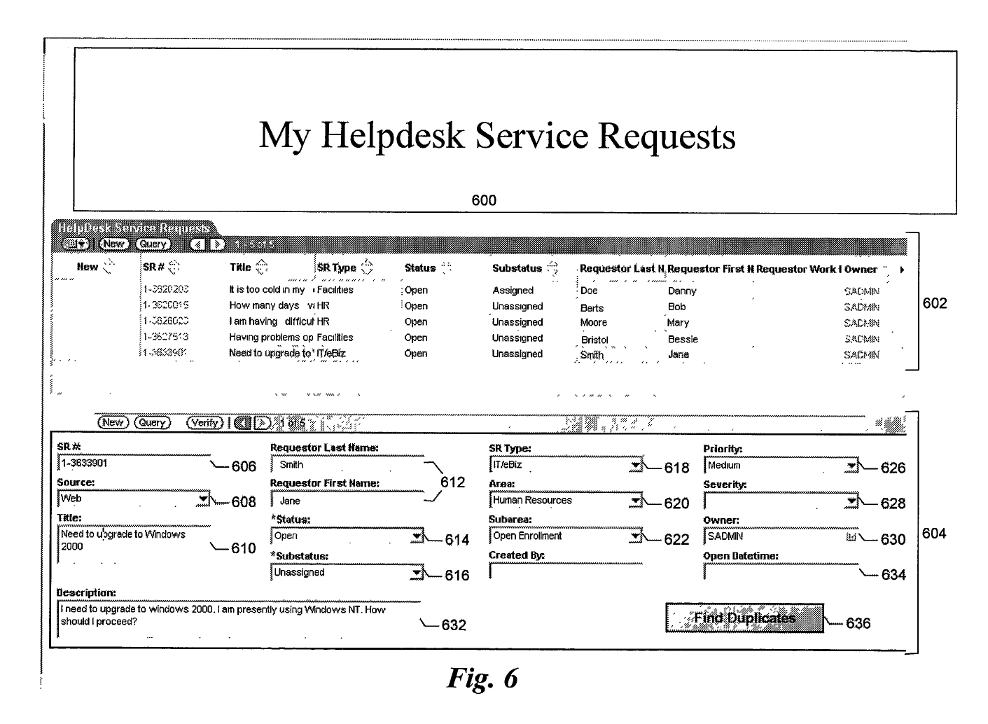

FIG. 6 is a sample user interface showing a web page 600 displaying pending service requests. In some embodiments, the “MY HELPDESK SERVICE REQUESTS” page 600 is available to helpdesk agents so that they may view service requests in order to process and address them. In some embodiments, the “MY HELPDESK SERVICE REQUESTS” page 600 contains two sections, an upper section 602 and a lower section 604. The upper section 602 is a list displaying all the pending service requests in the system. The lower section 604, in some embodiments, displays details for a single selected service request, including various fields containing information about a service request. As described above in conjunction with FIG. 5, the requester creating the service request, in some embodiments, provides much of the information contained in the displayed fields of the lower section 604 at the time the service request is created. In some embodiments, the helpdesk agent may modify some of the information provided by the requester and may also add new supplemental information, such as the information contained in a “STATUS” 614 field, a “SUBSTATUS” 616 field and a “SEVERITY” 628 field. Additionally, the system may be configured to provide some of the displayed information, such as the information in an “OPEN DATETIME” field 634, which indicates the date and time that a service request is submitted.

In some embodiments, an “SR NUMBER” field 606 displays the service request number assigned to the selected service request (e.g., 1-3633901). A “SOURCE” field 608 displays the source of the service request (e.g., web). In some embodiments, the title of the service request is displayed in a “TITLE” field 610. Similarly, information in a “DESCRIPTION” field 632 is displayed, which allows the helpdesk agent to acquire a high-level understanding of the submitted service request. Other fields in the service request in some embodiments include “REQUESTOR NAME” 612, “SR TYPE” 618, “SR AREA” 620, “SR SUBAREA” 622 and “PRIORITY” 626. In some embodiments, an “OWNER” field 630 and a “CREATED BY” field are also provided. The information in the “OWNER” field relates to identifying the particular helpdesk agent or individual assigned responsibility for handling the service request.

Values for the “STATUS” field 614 and the “SUBSTATUS” field 616 are provided by the helpdesk agent. For example, a service request that has not yet been completed or fully addressed may be assigned the status “open,” while a service request that has been fully addressed may be assigned the status “closed.” The “SUBSTATUS” field 616 relates to whether the service request has been assigned to a particular helpdesk agent. In this example, the information in the “SUBSTATUS” field 616 indicates that the service request has not yet been assigned.

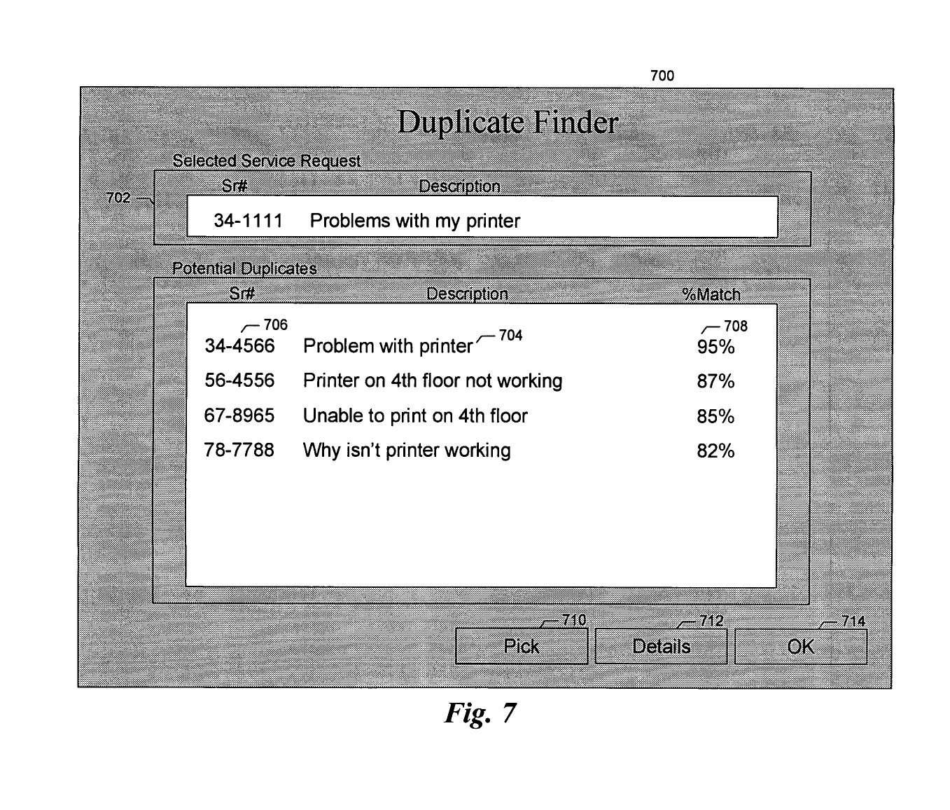

Once the helpdesk agent has reviewed the details of the selected service request as displayed in the lower section 604 of the “MY HELP DESK SERVICE REQUESTS” page 600, he or she may select a “FIND DUPLICATES” button 636 in order to determine whether the system contains other pending service requests that are based on the same problem indicated by the selected service request. Selection of the “FIND DUPLICATES” button 636 causes the display of a window showing potential duplicate service requests, such as the “DUPLICATE FINDER” window 700 of FIG. 7.

FIG. 7 is a first sample user interface showing a window or page 700 displaying potential duplicate service requests. In some embodiments, the system searches for duplicate service requests by comparing the words used in a description field of a selected service request 702 with the words used in description fields of other service requests that are pending in the system. More specifically, certain keywords may be identified in the selected service request. Pending service requests containing these words or portions of these words will be identified and displayed as possible matches. As FIG. 7 illustrates, the description of each of the four potential duplicate service requests contains some form of the word “print.” For reference and descriptive purposes, the service requests in some embodiments are displayed with a “DESCRIPTION” 704 and an “SR NUMBER” 706.

In some embodiments, a percent match 708 for each service request is also calculated and displayed alongside each service request listed in the “DUPLICATE FINDER” window 700. The percent match 708 objectively indicates the degree of similarity between the words in the description field of the selected request and the words in the description field of the identified service request. It is possible that the system may not identify potential duplicate service requests for a particular selected request. In such a case, the system may display a “no duplicates identified” message in the “DUPLICATE FINDER” window 700.

From the “DUPLICATE FINDER” window 700, the helpdesk agent may select or “pick” one or more of the potential duplicate service requests in order to confirm that these picked service requests should be handled as a group with the selected request. In order to do this, the helpdesk agent selects a service request and then selects a “PICK” button 710. Each “picked” service request is then tagged as relating to the selected service request and addressed accordingly. The helpdesk agent may also view the details of a selected service request by selecting a “DETAILS” button 712. For example, if the helpdesk agent selects the service request number 564556 indicating that the printer on the fourth floor is not working, and then selects the “DETAILS” button 712, a display showing the details of that particular service request is displayed. The display will be very similar to the detailed display of the service request in the “MY HELPDESK SERVICE REQUESTS” page 600 of FIG. 6. Selecting the “OK” button 714 causes the display of a screen showing the list of pending service requests, such as the “MY HELPDESK SERVICE REQUESTS” page 600 of FIG. 6. In some embodiments, once the “OK” button is selected, the system may notify requesters of picked service requests that their service requests will be addressed as a group of service requests.

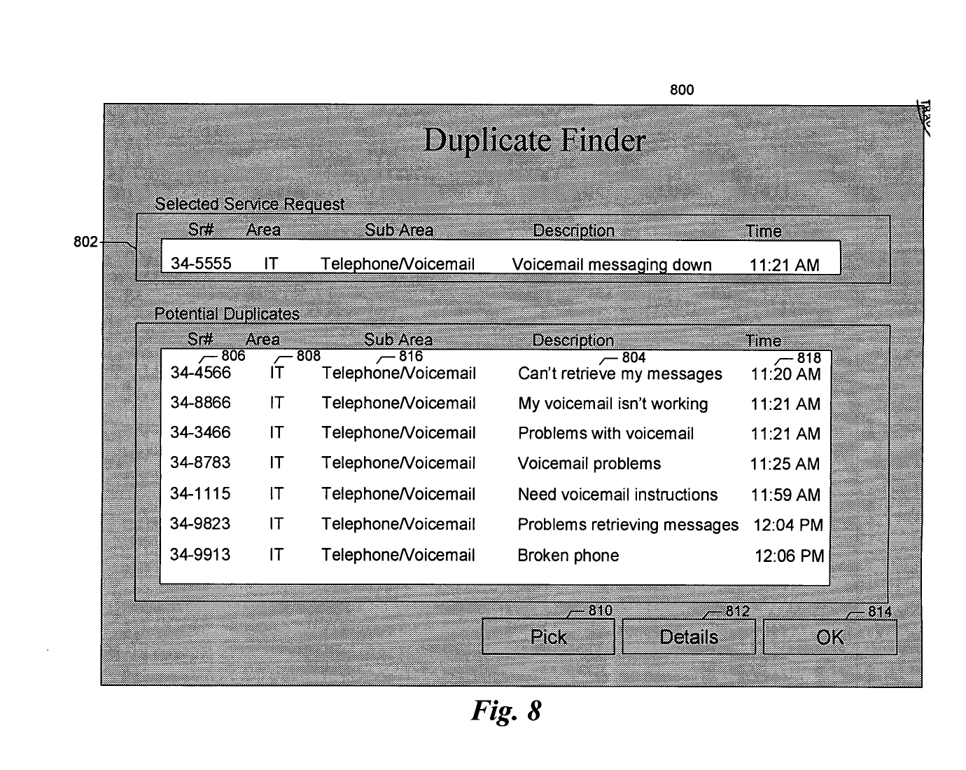

FIG. 8 is a second sample user interface showing a window or web page 800 displaying potential duplicate service requests. The “DUPLICATE FINDER” window 800, in some embodiments, displays potential duplicate service requests that are identified by the system using area and subarea fields, such as the “SR AREA” 506 and “SR SUBAREA” 508 fields of FIG. 5. Potential duplicate service requests may also be identified using submission time information, such as the “OPEN DATETIME” information 634 of FIG. 6. As illustrated in FIG. 8, the system has identified the seven displayed service requests as potential duplicates because of their matching “AREA” 808 (e.g., “IT”) and “SUBAREA” 816 (e.g., “telephone/voicemail”) fields and because the service requests were submitted at around approximately the same time 818 as a selected service request 802 (e.g., between the hours of 11:20 a.m. and 12:06 p.m. on a given day).

The “DUPLICATE FINDER” window 800 in some embodiments displays area 808, subarea 816, open datetime 818 and SR number 806 information for each displayed service request. Description information 804 is also provided so that the helpdesk agent may quickly and subjectively view each service request to confirm whether it is a duplicate. For example, although the service requests listed in the “DUPLICATE FINDER” window 800 of FIG. 8 all have matching areas and subareas, the description information for each service request indicates that some of the potential duplicates may not be duplicates at all. For example, a potential duplicate service request with the description “need voicemail instructions” may not be a duplicate to a selected service request indicating that “voicemail messaging is down.” Similarly, a service request indicating that a requestor has a “broken telephone” may also not be a duplicate service request. In such a case, where there is a question as to whether the displayed service request is a duplicate, the helpdesk agent may view the details of the seemingly out-of-place service request in order to make a subjective assessment of whether the service request is a duplicate. To do so, the helpdesk agent may select a service request and then select the “DETAILS” button 812.

Once the helpdesk agent assesses which of the listed potential duplicate service requests should be treated as duplicates, the helpdesk agent may then use the “PICK” button 810 to select all the service requests that he or she wishes to group together as duplicates. In some embodiments, grouping service requests in this way may result in a single trouble ticket being logged for the group of service requests. One of ordinary skill in the art would appreciate, however, that many other ways to address duplicate service requests may be implemented without departing from the scope of the invention. When the helpdesk agent has completed the process of using the “PICK” button 810 to group duplicate service requests, the helpdesk agent may select the “OK” button 814 to return back to the “MY HELPDESK SERVICE REQUESTS” page 600.

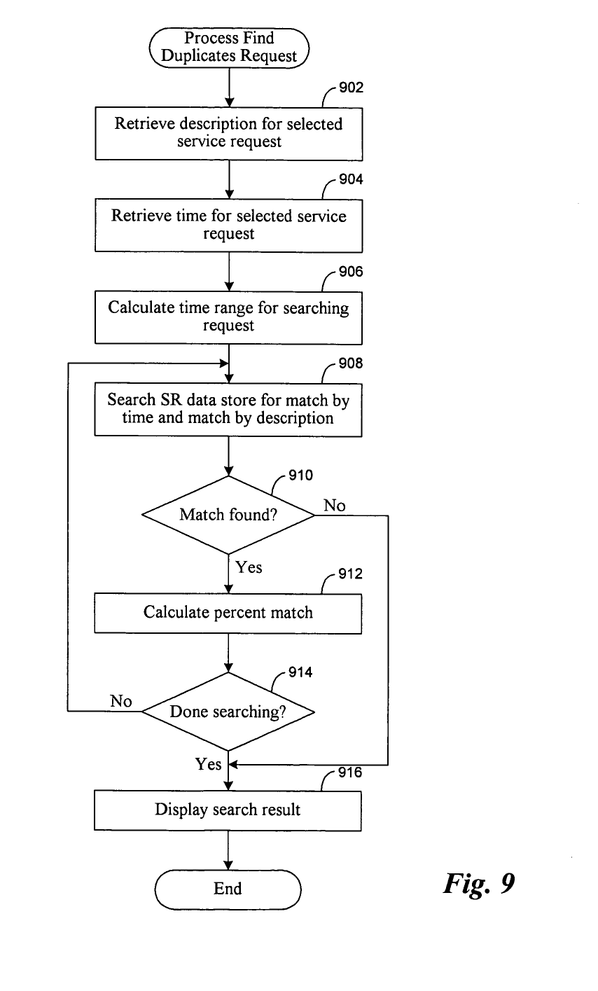

FIG. 9 is a flow diagram showing steps typically performed by the facility to process a find duplicates request in some embodiments. In some embodiments, the facility identifies duplicate service requests by comparing a submission time range and a description field in a selected service request with submission time fields and description fields in other pending service requests. In block 902, the facility retrieves the description information for the original selected service request. In block 904, the facility retrieves the submission time for the selected service request. In block 906, from the submission time information, the facility calculates a submission time range (e.g., 8:00 AM to 10:00 AM) to search for potential duplicate service requests that fall within this time range. In block 908, the facility searches pending service requests stored in a service request data store in order to identify service requests that fall within the calculated submission time range and that have description fields that partially match the description field of the selected service request. In decision block 910, if a match is not found, the facility continues at block 916, where the result of the search (e.g., “no duplicates found”) is displayed, else the facility continues at block 912, where the facility calculates the percent match using the description fields of the identified potential duplicate service request and the selected service request. In decision block 914, if all the service requests in the service request data store have been searched, the facility continues at block 916, where the search results are displayed, else the facility loops back to block 908, searching the service request data store for additional duplicate service requests.

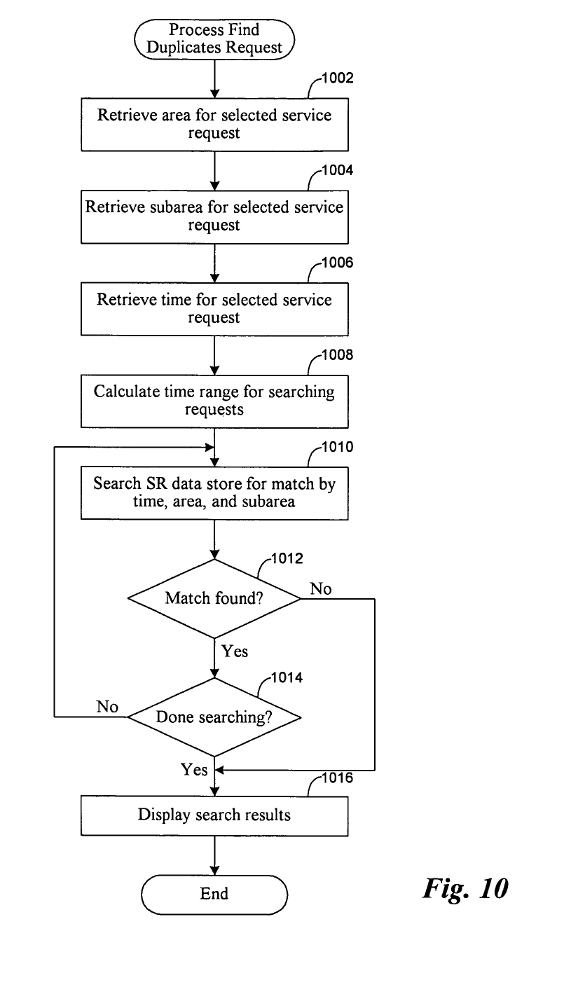

FIG. 10 is a flow diagram showing steps typically performed by the facility to process a find duplicates request in an alternate embodiment. In this alternate embodiment, the facility identifies duplicate service requests by comparing a submission time range, an area field and a subarea field with submission time fields, area fields and subarea fields in other pending service requests. In block 1002, the facility retrieves the area information for the selected service request. In block 1004, the facility retrieves the subarea information for the selected service request. In block 1006, the facility retrieves the time information for the selected service request. In block 1008, the facility calculates a submission time range in order to search for potential duplicate service requests falling within the calculated time range. In block 1010, the facility searches a service request data store for service requests that fall within the calculated submission time range and that have area fields and subarea fields that match the area field and the subarea field of the selected service request. In decision block 1012, if a match is not found, the facility continues at block 1016, where a “no matches found” search result is displayed to the user, else the facility continues at decision block 1014. In decision block 1014, if the facility is done searching, then the facility continues at block 1016, where all the search results containing the matched service requests are displayed, else the facility loops back to block 1010 and continues to search the service request data store for additional service requests that match by time, area and subarea.

### IV. CONCLUSION

From the foregoing, it will be appreciated that specific embodiments of the invention have been described herein for purposes of illustration, but that various modifications may be made without deviating from the spirit and scope of the invention. For example, although the above description refers to searching information by comparing specific combinations of fields of a specific type, one skilled in the art would recognize that many information types and many combinations of information might be compared without departing from the scope of the invention. Accordingly, the invention is not limited except as by the appended claims.

1. A method in a computer for identifying potential duplicate service requests, the method comprising:
receiving a service request identifying a problem;
searching a collection of pending service requests for a potential duplicate service request that is likely to identify the same problem as the received service request, wherein the problem is addressable by performing a single instance of an action of set of actions; and
where the potential duplicate service request is identified, consolidating the received service request and the potential duplicate service request into a single pending trouble ticket:
notifying a user of the pending trouble ticket.

2. The method of claim 1 wherein the searching is based on comparing a keyword in a description field for the received service request with one or more keywords in a description field for each service request in the collection of pending service requests.

3. The method of claim 1 wherein the searching is based on comparing a submission time for the received service request with a submission time for each of the service requests in the collection of pending service requests.

4. The method of claim 1 wherein the searching is based on comparing a submission time for the received service request with a submission time for each of the service requests in the collection of pending service requests and comparing a descriptive field of the received service request with a descriptive field for each of the service requests in the collection of pending service requests.

5. The method of claim 1 wherein the searching is based on comparing a standardized input field for the received service request with a standardized input field for each service request in the collection of pending service requests.

6. The method of claim 1 wherein the searching is based on comparing a plurality of standardized input fields for the received service request with a plurality of standardized input fields for each service request in the collection of pending service requests.

7. The method of claim 1 wherein the searching is based on comparing a title field for the received service request with a title field for each service request in the collection of pending service requests.

8. The method of claim 1 wherein the searching is based on comparing a topic field for the received service request with a topic field for each service request in the collection of pending service requests.

9. The method of claim 1 wherein the searching is based on comparing area and subarea fields for the received service request with area and subarea fields for each service request in the collection of pending service requests.

10. (canceled)

11. The method of claim 1 further comprising, where a potential duplicate service request is identified, prompting the user to confirm that the potential duplicate service request has the same basis as the received service request.

12. The method of claim 1 further comprising, where a potential duplicate request is identified, using a single trouble ticket to log the received service request and the potential duplicate service request.

13. A method in a computer for identifying potential duplicate service requests, the method comprising:
receiving a service request requesting assistance with solving a problem;
displaying an indication of the received service request;
retrieving description information and submission time information for the received service request;
based on the retrieved description information and the retrieved submission time information, searching a collection of pending service requests for a potential duplicate service request;
where a potential duplicate service request is identified, displaying an indication of the potential duplicate service request to a user responsible for addressing the received service request; and
consolidating at least the received service request and the potential duplicate service request into a single pending trouble ticket;
storing a result of the consolidating in memory.

14. The method of claim 13 further comprising prompting the user to confirm that the potential duplicate service request has the same basis as the received service request.

15. The method of claim 13 further comprising, where a potential duplicate service request is identified, consolidating the received service request and the potential duplicate service request together to form a single service request.

16. The method of claim 13 further comprising, where a potential duplicate service request is identified, using a single trouble ticket to log the received service request and the potential duplicate service request.

17. The method of claim 13 further comprising, where a potential duplicate service request is identified and the user confirms that the potential duplicate service request has the same basis as the received service request, sending notifications that the received service request and the potential duplicate service request have been acknowledged.

18. A computer-readable medium comprising instructions that cause a computer system to identify duplicate service requests by performing a method comprising:
receiving service request information, wherein the received service request information comprises an indication of a basis for a service request and an indication of the time that the service request was submitted;
based on the basis for the received service request and the indication of the time when the service request was submitted, searching a collection of pending service requests for a potential duplicate service request having the same basis as the received service request; and
where the potential duplicate service request is identified, consolidating the received service request and the potential duplicate service request into a single pending trouble ticket so that the problem with the device identified in both the received service request and the potential duplicate service request are addressable by performing the single instance of the action or set of actions.

19. The computer-readable-medium of claim 18 wherein the searching includes comparing a keyword in a description field for the received service request with one or more keywords in a description field for each service request in the collection of pending service requests.

20. The computer-readable medium of claim 18 wherein the searching includes comparing area and subarea fields for the received service request with area and subarea fields for each service request in the collection of pending service requests.

21. (canceled)

22. A computing system for identifying potential duplicate pending service requests, the pending service requests requesting assistance with solving a problem, the system comprising:
a display device on which is displayed information describing submitted pending service requests and information indicating the possibility of duplicate pending service requests;
a storage device storing information related to submitted pending service requests;
a user input module that receives a plurality of instances of user input, each instance related to viewing submitted pending service requests;
a comparison subsystem that, in response to the receipt of received user input by the input module, compares the information stored in the storage device with information relating to a selected pending service request displayed by the display device to identify duplicate service requests from the submitted pending service requests stored in the storage device; and
a consolidation subsystem that consolidates at least the submitted service request and the duplicate service requests into the single pending trouble ticket;
a memory coupled to the consolidation subsystem for storing a result of the consolidating the least the submitted service request and the duplicate service requests into a single pending trouble ticket.

23. The computer system of claim 22 further comprising a notification subsystem that notifies senders of received service requests when duplicate service requests are identified.

24. (canceled)

25. (canceled)
